(19) United States
(12) Patent Application Publication
(10) Pub. No.: US 2004/0221016 A1
(43) Pub. Date: Nov. 4, 2004

(54) Method and apparatus for preventing transmission of unwanted email

(76) Inventors: James A. Hatch, Carlsbad, CA (US); Brian Halderman, San Marcos, CA (US)

Correspondence Address: GORDON & REES LLP, 101 WEST BROADWAY, SUITE 1600, SAN DIEGO, CA, 92101, US

(21) Appl. No.: 10/427,854

(22) Filed: May 1, 2003

(51) Int. Cl. G06F 15/16

(52) U.S. Cl. 709/207

(57) ABSTRACT

A method and apparatus to prevent the transmission of unwarranted email in which identification information for an email is analyzed prior to granting a sender authorization to transmit a message within a communication protocol. At the user server, communication with an incoming message is established by a communication technique, for example, an initial handshake procedure. At the incoming server, header information following the handshake signal is analyzed. Header information may commonly identify an originating server and email address, as well as an intended receiver address. The mail server compares header data to an authorization list, which could comprise a black list. Identification of an unauthorized sender generates a flag which is utilized to generate an unauthorized message notification to the sender. The unauthorized message notification to the sender is achieved before the sender has had the opportunity to send the entire message. The notification to the sender of the unauthorized status effectively revokes the handshake authorization and prevents transmission of data to the user.

The present invention relates to multicomputer data transferring, and more particularly to filtering of communications and management of connection to network resources.

### BACKGROUND OF THE INVENTION

Electronic mail (email) has become a widely used medium upon which people have come to rely for interpersonal and business communications. Email has major advantages compared to physical means of communication such as the postal service. Email is very low cost, very fast and may be broadcast or narrowcast, as well as being sent to an individual. Emails may include photographic, audio-visual attachments and text formatted in accordance with popular computer programs such as WordPerfect or PowerPoint.

The same advantages that make it easy for people to send communications desired by the recipients also make it easy for others to send unwanted or unsolicited email, often referred to as “junk-email” or “spam.” Public outcry by email users has been heard by legislatures throughout the world, which have begun enacting laws to restrict the continued proliferation of junk-email. One technique for limiting undesired email is to require mass mailers to provide recipients with a means for being removed from a mailing list. The means include letting the recipient respond to the email with an “unsubscribe” message or providing a link in the email so a user may “click here” to be removed from the mailing list. These links are often useless to recipients since a spammer may use a false email address. When a recipient seeks to “unsubscribe,” the recipient will receive a message that the email address to which the message has been forwarded does not exist, or the recipient may receive a message that the mail box is full. Another technique used by spammers is the provision of an inoperative link.

A variety of methods have been devised to address the problem of junk email, and spammers have developed their own avoidance techniques. The most common approaches in filtering are personal whitelists, personal blacklists, or general shared blacklists, mass blacklists and mass whitelists. Whitelists block all messages except those on the list. Blacklist filters allow all messages, except those on the list. Such filtering is available in common email services such as Microsoft Outlook, Hotmail and AOL as a junk mail filter option. The personal list approach requires a user to input into a filter a set of email addresses. The whitelist filter approach defines a universe of the only senders from which a user may receive email. Since this approach assumes any email address not listed, is not an email address from which the user wishes to receive email, email that is from desired sources not already listed is not delivered. It is not practical for an email user to anticipate all email addresses of potential desired mail senders. Therefore, simple whitelist-based filters are typically considered too restrictive for practical use.

In contrast blacklists assume that any email address not listed represents the email address from which the user desires to receive email. In addition to availing themselves of personal lists, users may avail themselves of service by Internet Service Providers who use mass blacklists to block entire ranges of mail servers based on the IP address of the mail servers. General shared blacklists are generated by companies such as Brightmail and Postini who generate public blacklists for use by email service providers (ESPs) such as those listed above. The general shared blacklists have been able to block or discourage many of the less capable junk-emailers. However, sophisticated spammers can circumvent the general shared blacklists. They do this by such techniques as “tumbling” their email addresses or other identifying characteristics or putting false email addresses in message headers. Typical success rates of personal blacklists in blocking junk-email are only 25% to 60%. The use of general, mass blacklists still provides incomplete protection.

The use of mass blacklists creates an additional problem for legitimate email users. IP addresses that are no longer used are eventually recycled. This includes blacklisted addresses. However, the organizations that issue recycled IP addresses do not issue notifications to maintainers of collective blacklists such as cauce.org and spews.org, for example. Therefore, IP addresses ceasing to be associated with spammers will not be removed from the blacklist. The new proprietor of a recycled blacklisted IP address will not have any way of knowing this and will only find out after having encountered problems in communicating with the user=s audience. The proprietor will have great difficulty in getting the IP address removed from blacklists. Simply obtaining a new non-blacklisted IP address is also a difficult alternative due to the difficulties associated with migrating all communications to the new address.

Some email filters read entire messages. While this form of filtering can flag much undesired email that might not be caught by header information, it can result in “false positive” identification of undesired mail and result in interception of desired mail. Reading entire messages requires a significant commitment of resources.

Once an undesired email message is flagged, a system must act on this information. The conventional prior art technique is to deliver accepted messages to an inbox folder of a user and to deliver intercepted messages to a trash or bulk-mail folder. In each case, the entire email message is processed. System resources are utilized for storing undesired messages as well as desired messages. Processing of undesired emails consumes bandwidth that would otherwise be available for processing desired emails. Further, storage capacity resources are taxed by the need to store the junk-email. In many systems, junk-email is stored so that a user can review, if desired, the list of rejected emails to be able to retrieve desired emails that were rejected due to the occurrence of a false positive. When integrated over the accounts of a large number of users, an ISP or an ESP has its effective service capacity for dollars worth of equipment required to meet user needs significantly diminished by the presence of undesired email. It would be highly desirable to provide a method and means in which system resources are not taxed due to the attempted entry of undesired emails

### SUMMARY OF THE INVENTION

It is therefore a particular advantage of the present invention to provide a method and apparatus for preventing transmission of unwanted email in which identification information for an email is analyzed prior to granting a sender authorization to transmit a message within a communication protocol.

Briefly stated, in accordance with the present invention, there are provided a method, an apparatus and program product in which a filtering function is provided in the process in which network communication from an external source to a user is established. At a server, communication with an incoming message is established by a communication technique, for example, a handshake procedure. At the server, header information following the handshake signal is analyzed. Header information may commonly identify an originating server and email address, as well as an intended receiver address. The server compares header data to a list or lists. Identification of an unauthorized sender generates a flag which is utilized to generate an unauthorized message notification to the sender. The unauthorized message notification to the sender is achieved before the sender has had the opportunity to send the entire message. The notification to the sender having unauthorized status effectively revokes the handshake authorization and prevents transmission to the user.

In the preferred form, senders without authorization will have the ability to send one message to a user, if the user has configured its account to allow the initial transmission. The user then has the option to identify the sender as an unauthorized source to the administration function of the server so that no further messages will be received by that server. Since messages are prevented from being transmitted to the user, unauthorized messages need not be stored. No “false positives” will be generated to prevent transmission of desired messages.

### BRIEF DESCRIPTION OF THE DRAWINGS

The invention may be further understood by reference to the following description taken in connection with the following drawings.

FIG. 1 is a block diagram of a communication system incorporating the present invention;

FIG. 2 is an illustration of network protocols utilized in communicating between host computers;

FIG. 3 is an illustration of a packet transmitted between host computers and a network;

FIG. 4 is a flow diagram illustrating operation of the present invention; and

FIG. 5 is a block diagram illustrating the server of FIG. 1 in greater detail.

### DETAILED DESCRIPTION OF THE INVENTION

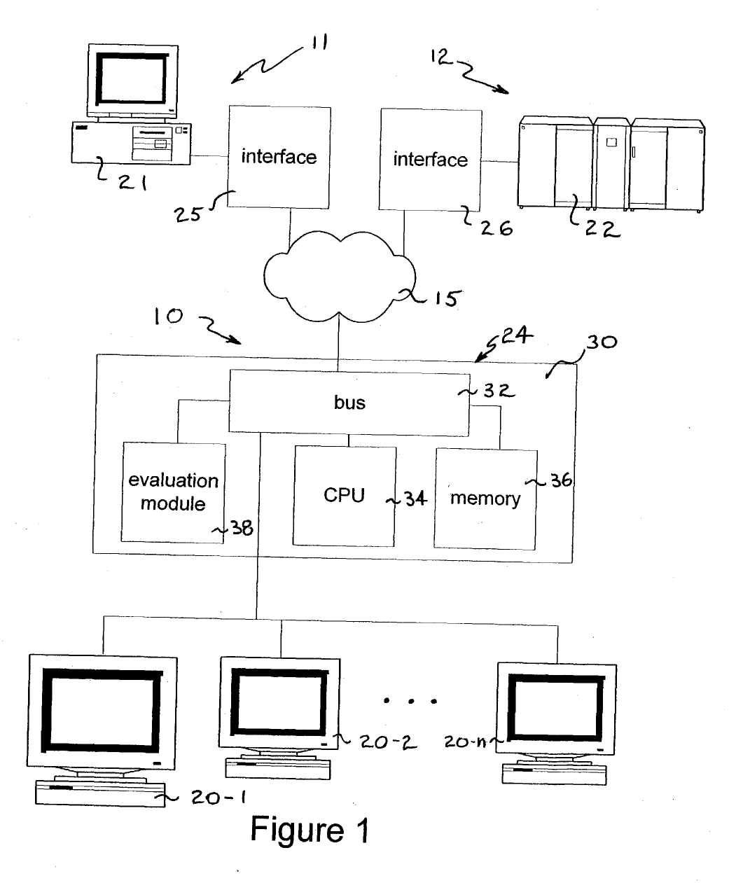

FIG. 1 illustrates a telecommunication system 1 in which various networks 10, 11 and 12 interact with each other via a communication channel such as the Internet 15. The networks 10, 11 and 12 may each comprise connections to further systems and may be considered to be illustrative of the Internet 15 in general. In each of the networks 10, 11 and 12, at least one user 20, 21 or 22 communicates via the Internet 15. A plurality of users 20-1, 20-2 . . . 20-n are illustrated in the network 10. Each user 20 could comprise an individual personal computer coupled to an Internet service provider 24 using a server 30. In the networks 11 and 12, representative users 21 and 22 connect to the Internet 15 via coupling devices 25 and 26 respectively. The server 30 includes a bus 32, CPU (central processing unit) 34, memory 36 and list management module 38. In the network 10, the Internet service provider 24 provides email service at a server 30. The server 30 comprises an interface to the Internet 15.

The server 30 includes machine readable media. A machine-readable medium includes any mechanism that provides (i.e., stores and/or transmits) information in a form readable by a machine, for example, a computer. For example, a machine-readable medium includes read only memory; random access memory (RAM); magnetic or optical disk storage media and may also include electrical, optical, acoustical or other forms of propagated signals.

The present invention could also be used in the context of wide area networks or local area networks. The message processing and management capability provided in accordance with the present invention need only be inserted between a sender and a receiver in a communication path. The example of the Internet is chosen since there is a great need in the art to avoid receipt of unwanted email over the Internet.

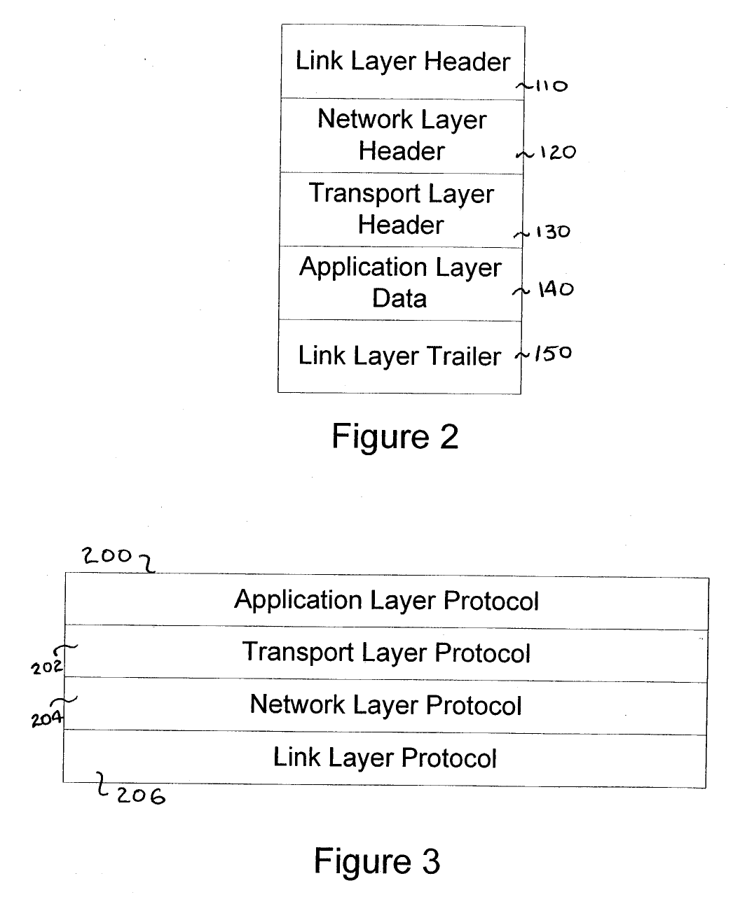

Commonly, Internet communication is accomplished by transmission of successive packets. FIG. 2 is an illustration of a nominal packet 100. The packet 100 comprises a plurality of headers, a data section and a trailer. In the present example, there are three headers, a link layer header 110, a network layer header 120, and a transport layer header 130. The headers 110, 120 and 130 each include address information and the so-called overhead information used to define how the packets will be routed. The headers each conform to standards of particular protocols within which they are used. A number of standard protocols are available. The particular protocol used does not form part of the present invention. An identification of protocols used in the present exemplification is further discussed with respect to FIG. 3 below. The packet 100 further comprises a data field 140 is provided which contains content. The data may include text, video, images or any other data currently or in the future transmittable over networks. A link layer trailer 150 indicates the end of the packet. This form of packet is used within the network protocol of the system 1.

The system protocol utilized in the present example is illustrated in FIG. 3 and comprises four layers. There is an application layer protocol 200, a transport layer protocol 202, a network layer protocol 204 and a link layer protocol 206. The application layer protocol 200 defines the type of transmission that will be performed. In the present example, the application layer protocol will be SMTP (Simple Mail Transfer Protocol). However, other applications may be used which will employ their own protocols. Other application layer protocols are FTP (File Transfer Protocol), HTTP (Hyper Text Transfer Protocol), Telnet, and POP. A transport layer protocol 202 ensures that packets 100 are reliably transmitted between the network interface devices. Another protocol, namely the network layer protocol 204 must be used to generate and transmit packets within each of the networks 10, 11 and 12. Finally, there is a link layer protocol 206 to link the various users 20, 21 or 22 to the networks 10, 11 or 12. The most common Internet form of connection is TCP/IP. This means that the transport layer protocol 202 comprises TCP (Transmission Control Protocol) and the network layer protocol 204 comprises IP (Internet Protocol). Alternatives to TCP are SPX (Sequenced Exchange) or UDP (User Datagram Protocol). For the network protocol 204 an alternative is IPX (Internet Packet Exchange). Common link layer 206 protocols are Ethernet or Token ring.

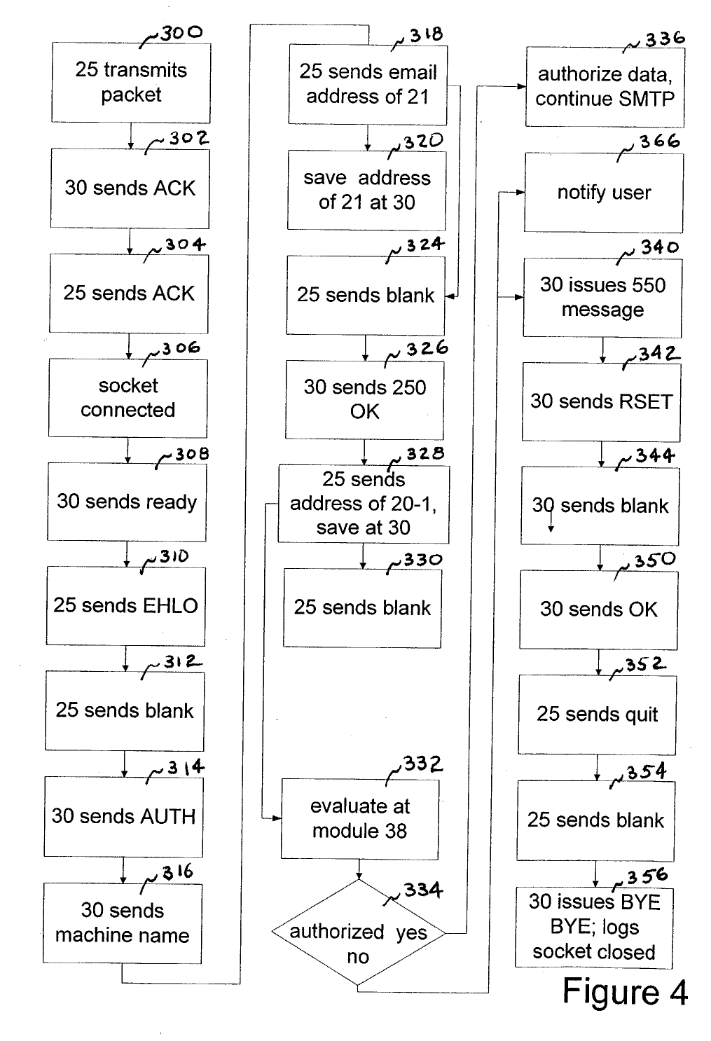

Communication between computers, such as the interface users 22 in the network 11 and the user 20-1 is normally visualized as a continuous communication. In fact, a number of steps must be completed before the connection is established. FIG. 4 is an illustration of communication between the server 30 and another server, illustrating nominal communications protocols at various levels and the interaction within the present invention. In the present example, it is assumed that a remote sender, e.g., user 21, is communicating via the interface 25 and is attempting at block 300 to send a message to a user such as user 20-1 who is served by the ISP 24 and server 30. The message could be an email message. Other messages, e.g., a SMS (short message service) message could be processed between the networks 10, 11 and 12. Initially, connections are established in the transport layer and the network layer through the use of TCP/IP protocols in the present example. Other well-known protocols may be used in other embodiments. In order to establish a connection, the server 25 transmits a packet to the protected server 30 including a transport layer header essentially requesting a connection with the server 30. At block 302, the server 30 responds with an acknowledgment to inform the server 25 that a connection may be made. At block 304, the server 25 sends its own acknowledgment, thus completing a sending handshake operation. A transport layer connection is opened between the server 25 and the server 30. Now that there is a connection at the transport layer and the network layer, operation proceeds to an application layer protocol 200 (FIG. 3). In the present example, email is being sent, and an SMTP protocol will be utilized. Of course, as explained above, many protocols are available.

At block 306, a socket connected operation occurs. The server 25 connects to the server 30 and the server 30 opens a logfile to store interactions. This transmission includes the IP address of the server 25. At block 308, the server 30 sends a ready signal to the server 25. The server 25 is now enabled to send further information and at block 310 sends an EHLO (or HELO) outgoing signal which includes the machine name of the sending computer 21. The server 25 thus lets the server 30 know who it is and what its capabilities are. At block 312, the server 25 sends a blank line to announce that the next function is coming. At block 314, the server 30 responds with an AUTH login signal to let the server 25 know it may proceed. At block 316, the server 30 sends its machine name to the server 25. A next step occurs at block 318 wherein the server 25 provides the email address of the user 21 to the server 30. At block 320, in accordance with the present invention, the received email address is saved by the server 30, e.g. in memory 36 (FIG. 1). The protocol continues at block 324 at which the server 25 sends a blank line to inform the server 30 that the next function is coming. At block 326, the server 30 sends a “250” signal to permit the next step. At block 328 the server 25 provides the email address of the addressee user 20-1. This email address is sent to memory 36.

At block 330 the communications protocol continues with the sending of a blank line from server 25. During this period, at block 332, the sender's address received at block 318 and the addressee's address received at block 328 will have been sent to the email evaluation module 38 (FIG. 1).

During the step at block 330, at block 334, address information is evaluated. In this step, the email address of the sender received at block 320 is evaluated. The addressee address used at block 332 corresponds to and accesses a list established by or on behalf of the user 20-1.

If the mail is authorized, operation proceeds to block 336 at which receipt of further information from the server 25 is authorized and email is forwarded to the account of the user 20-1. The SMTP protocol is completed in a normal manner.

If the evaluation reveals user 21 to be an undesired sender, operation proceeds to block 340 in which the server 30 issues a “550” message which is a message informing the server 25 that transmission is blocked. The sending server 25 understands the “550” message and resets, i.e. closes the connection. A register may be provided in the evaluation circuit 28 whereby in addition to a reset message, the server 25 also notifies the user 21 via the server 25 that the user 20-1 is providing an electronic notice of request to remove the user 20-1 from the mailing list of the user 21. At block 342, the server 25 sends a RSET signal to announce the reset function which says the connection will be closed. At block 344, a blank line is sent by the server 25 to announce that the next function is coming and at block 346, the server 30 issues a “250” okay command acknowledging it understands the reset command. In response thereto, at block 352, the server 25 sends a quit signal to close the connection. At block 354, the server 25 sends a blank line. At block 356, the server 30 closes the connection by issuing a “221” code signifying the understanding of the disconnection, and, the server 30 documents its log with a “socket” message to denote that the connection is indeed closed.

Additionally, following block 340 or following block 336, when the decision is made not to authorize the message, an operation at block 366 may be provided wherein the email account of the user 21 is notified that a connection was refused. In this manner, the user 21 may query the ESP 24 to establish that mail was rejected from a particular source. It is important to note that the message from the user 21 was rejected before data could be sent. The network 10 did not need the bandwidth to accommodate an undesired email message. The ESP 30 does not need the storage capacity to accommodate undesired messages.

FIG. 4 represents one preferred, idealized form of implementation of the SMTP protocol. Many other well-known sequences of operation may be used to achieve communications. For example, any block requiring server statements or responses, of which the block 310 is one, may vary in accordance with a particular version of a protocol. Some versions of the SMTP protocol may use an HELO response as opposed to the EHLO response, or may use neither. The invention may interact in a wide range of protocols.

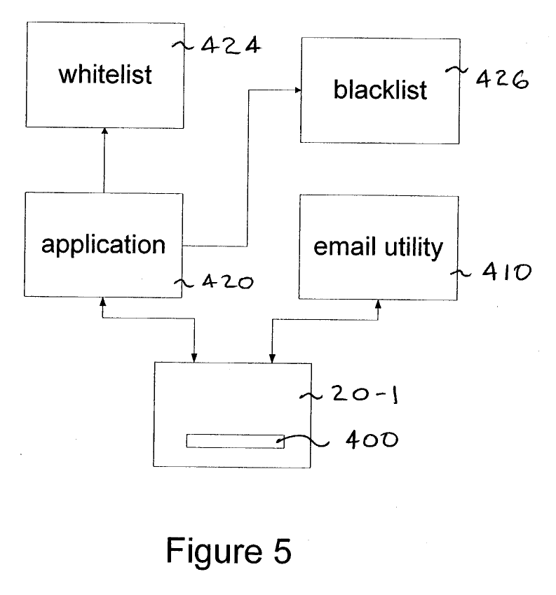

FIG. 5 is an illustration of a means for administering the authorization list and also serves to illustrate a method therefore. In FIG. 5, the user 20-1 through a user interface, for example, a keyboard 400 interacts with an application 420 within the ESP 30. The user 20-1 adds email addresses and signifies whether the application 420 shall place email addresses on a whitelist 430 or a blacklist 426. Further, the user 20-1 may instruct the application to transfer selected addresses or a selected address from one list 430 or 426 to the other.

In this system, an undesired sender 21 can contact the user 20-1 once. In order to place the undesired sender on the application list, the user 20-1 selects undesired senders from his email utility 410 for placing on the blacklist 430.

It is important to note that the present invention does not simply utilize the IP address of a sender in order to screen for desirable or undesirable senders. IP addresses can be reassigned from one user 21 to another. Greater certainty and identification of the actual sender is achieved by utilizing the email address in the field analyzed.

The specification has been written with a view toward enabling those skilled in the art to make many modifications and the specific embodiments disclosed while providing a method, apparatus and programmed device constructed in accordance with the present invention.

What is claimed is:

1. In a method of performing a communications protocol for communications between a client and a server comprising the steps of setting a mailer, setting a recipient, and sending a message from the client to the server, the protocol including a step for the server to issue a disconnect command to the client, the improvement comprising:
storing data indicative of the sender in response to setting the sender;
receiving the identity of the recipient in response to setting the recipient;
selecting a list in correspondence with identity of the recipient;
evaluating identity of the sender for presence or absence from said list and enabling or disabling the sending of the message in accordance with the presence or absence from the list.

2. The improvement of claim 1 wherein disabling comprises sending a reset signal from the server to the client.

3. The improvement according to claim 2 comprising issuing a further signal comprising at least an extra bit to notify the sender that the recipient is not to be contacted in the future.

4. The improvement of claim 3 further comprising establishing a list at a user and communicating the list from the user to the server.

5. The improvement according to claim 4 wherein establishing a list by the user comprises establishing a whitelist and blacklist.

6. The improvement according to claim 5 further comprising selectively transferring sender identities from one of said whitelist or said blacklist to the other.

7. A machine readable medium that provides instructions which when executed by a processor cause the processor to perform operations comprising:
stirring an address of a sender identified in response to setting of a sender by a client;
selecting a list identified in correspondence with identity of a recipient identified in a step of setting a recipient;
prior to enabling sending of message from the client to the server evaluating identity of the sender for presence on the list and enabling or disabling sending of the message in accordance with the presence or absence.

8. The machine readable medium according to claim 7 wherein disabling comprises issuing a reset signal from said server to said client.

9. The machine readable medium according to claim 8 further comprises sending in conjunction with said reset signal a further signal to notify the sender that the receiving server is not to be contacted in the future.

10. The machine readable medium according to claim 9 further comprising issuing a signal to a user that sending of a message has been disabled in conjunction with sending said reset signal.

11. The machine readable medium according to claim 10 further comprising establishing said list in conjunction with inputs from a user.

12. The machine readable medium according to claim 11 including establishing a whitelist and a blacklist in response to inputs from a user.

13. A system for filtering messages between a sender and receiver via a communication protocol comprising a register for stirring an address of a sender in response to setting of the sender;
a register for stirring identity of recipient in response to setting identity of the recipient;
an evaluation module comprising means for storing a list or lists, addressing means responsive to said addressee register for selecting a list in accordance with identity of the recipient and in comparison means for comparing identity of the sender with contents of the list and issuing a signal and correspondence with presence or absence of the sender's identity from a list;
command means responsive to the output of the comparison means to issue a signal selectively enabling or disabling sending of the message in correspondence with the presence or absence.

14. This system of claim 13 wherein said means for disabling comprises means for issuing a reset signal from said server to said client.

15. This system according to claim 14 further comprising means for issuing a signal to said client to advise the sender that the recipient is not to be contacted in the future in conjunction with issuance of a reset signal.

16. The system of claim 15 further comprising means for issuing a signal to a user indicative of a message transmission having been disabled.

17. A system according to claim 16 wherein said list register comprises means for storing a whitelist and a blacklist.

18. The system according to claim 17 comprising means for responding to user input for list maintenance.
